(19) United States
(12) Patent Application Publication
(10) Pub. No.: US 2014/0314508 A1
(43) Pub. Date: Oct. 23, 2014

(54) KEY COPYING

(71) Applicant: Outbox, Inc., Austin, TX (US)

(72) Inventors: Jason Gregory SERIFF, Austin, TX (US); Donald Stephen HAGA, III, Austin, TX (US); William Jewell DAVIS, JR., Austin, TX (US)

(21) Appl. No.: 13/868,382

(22) Filed: Apr. 23, 2013

(51) Int. Cl. B23C 3/35

(52) U.S. Cl. CPC B23C 3/35; B23C 2220/36; B23C 2235/12
USPC 409/81

(57) ABSTRACT

Embodiments of the present invention generally relate to producing a physical copy of a key from a digital image of a key. A software program receives a digital image of a key. Based on physical ratios of the key, the software program can determine a key blank corresponding to the key. After determining the key blank, the software program can determine a key code of the key, which may then be used to produce a physical copy of the key.

### BACKGROUND OF THE INVENTION

1. Field of the Invention

Embodiments described herein generally relate to producing physical copies of keys.

2. Description of the Related Art

A key is an instrument that is used to operate a lock. A typical key is a small piece of metal consisting of two parts: the blade, which slides into the keyway of the lock and distinguishes between different keys, and the bow or head, which is left protruding so that torque can be applied by the user. A key is usually intended to operate one specific lock or a small number of locks that are keyed alike, so each lock requires a unique key. The key serves as a security token for access to the locked area; only persons having the correct key can open the lock and gain access.

Key duplication is available through a locksmith. However, the locksmith needs to be in possession of a key in order to make a duplicate of the key. Not only is this inconvenient for the possessor of the key, for example, by requiring travel to a locksmith, it can at times be impossible, such as when the only copy of a key is lost.

Therefore, there is a need in the art for a method of copying keys.

### SUMMARY OF THE INVENTION

Embodiments of the present invention generally relate to producing a physical copy of a key from a digital image of a key. A software program receives a digital image of a key. Based on physical ratios of the key, the software program can determine a key blank corresponding to the key. After determining the key blank, the software program can determine a key code of the key, which may then be used to produce a physical copy of the key.

In one embodiment, a method of determining a key code comprises receiving a selection of a key head of a key, receiving a selection of a baseline of the key, receiving a selection of a tip distance of the key, receiving a selection of a key stop of the key, receiving a selection of groove positions on the key, and determining a key code for the key.

In another embodiment, a method of determining a key code comprises receiving a digital image of the key, receiving a selection of a key head of the key, receiving a selection of a baseline of the key, and receiving a selection of a tip distance of the key. The method also includes receiving a selection of a key stop of the key, receiving a selection of groove positions on the key, referencing a library including information regarding key blanks, determining one or more key codes for the key, and determining a probability corresponding to each key code or each digit in each key code.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an example of a system, according to one embodiment of the invention.

FIG. 2 is a flow diagram illustrating a method of determining a key code, according to one embodiment of the invention.

FIGS. 3A-3G illustrate operations during determination of a key code, according to one embodiment of the invention.

FIG. 4 illustrates a key head library, according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention generally relate to producing physical copies of keys from a digital image of a key. A software program receives a digital image of a key. Based on physical ratios of the key, the software program can determine a key blank corresponding to the key. After determining the key blank, the software program can determine a key code of the key, which may then be used to produce a physical copy of the key.

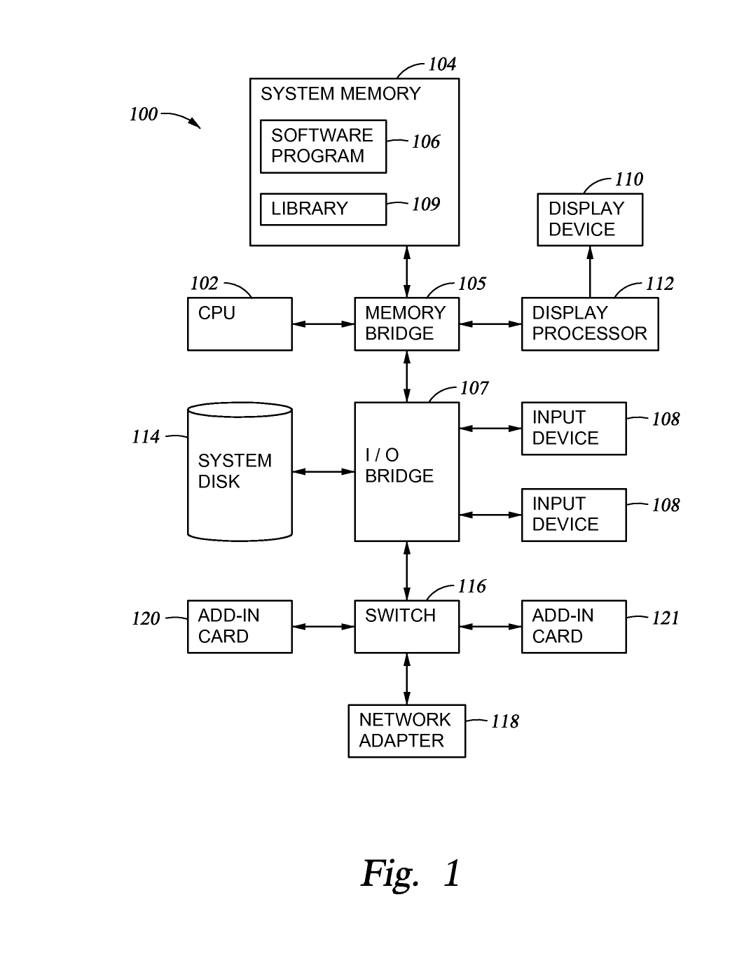

FIG. 1 is a schematic illustration of a system 100 configured to implement one or more aspects of the invention. As shown, system 100 includes a central processing unit (CPU) 102 and a system memory 104 communicating via a bus path that may include a memory bridge 105. The CPU 102 includes one or more processing cores, and, in operation, the CPU 102 is the master processor of the system 100, controlling and coordinating operations of other system components. The system memory 104 stores software applications and data for use by the CPU 102. The system memory 104 may store, for example, a software program 106 adapted to determine a key code from a digital image of a key, and a library 109 containing data related to keys, such as digital images of keys and physical dimensions and ratios of known keys. The CPU 102 runs software applications and optionally an operating system. The memory bridge 105, which may be, e.g., a Northbridge chip, is connected via a bus or other communication path (e.g., a HyperTransport link) to an I/O (input/output) bridge 107. The I/O bridge 107, which may be, e.g., a Southbridge chip, receives user input from one or more user input devices 108 (e.g., a mouse, a keyboard, or a camera) and forwards the input to CPU 102 via memory bridge 105.

An optional display processor 112 is coupled to memory bridge 105 via a bus or other communication path (e.g., a PCI Express, Accelerated Graphics Port, or HyperTransport link). In one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within the system memory 104.

The display processor 112 periodically delivers pixels to an optional display device 110 (e.g., a screen or conventional CRT, plasma, LED, OLED, SED or LCD based monitor or television). Additionally, the display processor 112 may output pixels to film recorders adapted to reproduce computer generated images on photographic film. The display processor 112 can provide the display device 110 with an analog or digital signal.

A system disk 114 is also connected to the I/O bridge 107 and may be configured to store content and applications and data for use by the CPU 102 and the display processor 112. The system disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O the bridge 107 and other components such as a network adapter 118 and various optional add-in cards 120 and 121. The network adapter 118 allows the system 100 to communicate with other systems via an electronic communications network, and may include wired or wireless communication over local area networks and wide area networks such as the Internet.

Other components (not shown), including USB or other port connections may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, the display processor 112 incorporates circuitry optimized for graphics and video processing, including, for example, video output circuitry, and constitutes a graphics processing unit (GPU). In another embodiment, the display processor 112 incorporates circuitry optimized for general purpose processing. In yet another embodiment, the display processor 112 may be integrated with one or more other system elements, such as the memory bridge 105, the CPU 102, and the I/O bridge 107 to form a system on chip (SoC). In still further embodiments, the display processor 112 is omitted and software executed by the CPU 102 performs the functions of the display processor 112.

Pixel data can be provided to the display processor 112 directly from the CPU 102. In some embodiments of the present invention, instructions and/or data representing a scene are provided to a render farm or a set of server computers, each similar to the system 100, via the network adapter 118 or the system disk 114. The render farm generates one or more rendered images of the scene using the provided instructions and/or data. These rendered images may be stored on computer-readable media in a digital format and optionally returned to the system 100 for display. Similarly, stereo image pairs processed by the display processor 112 may be output to other systems for display, stored in the system disk 114, or stored on computer-readable media in a digital format.

Alternatively, CPU 102 provides the display processor 112 with data and/or instructions defining the desired output images, from which the display processor 112 generates the pixel data of one or more output images, including characterizing and/or adjusting the offset between stereo image pairs. The data and/or instructions defining the desired output images can be stored in the system memory 104 or graphics memory within the display processor 112. In an embodiment, the display processor 112 includes 3D rendering capabilities for generating pixel data for output images from instructions and data defining the geometry, lighting shading, texturing, motion, and/or camera parameters for a scene. The display processor 112 can further include one or more programmable execution units capable of executing shader programs, tone mapping programs, and the like.

It will be appreciated that the system shown herein is illustrative and that variations and modifications are possible. The connection topology, including the number and arrangement of bridges, may be modified as desired. For instance, in some embodiments, the system memory 104 is connected to the CPU 102 directly rather than through a bridge, and other devices communicate with the system memory 104 via the memory bridge 105 and the CPU 102. In other alternative topologies the display processor 112 is connected to the I/O bridge 107 or directly to the CPU 102, rather than to the memory bridge 105. In still other embodiments, the I/O bridge 107 and the memory bridge 105 might be integrated into a single chip. The particular components shown herein are optional; for instance, any number of add-in cards or peripheral devices might be supported. In some embodiments, the switch 116 is eliminated, and the network adapter 118 and the add-in cards 120, 121 connect directly to the I/O bridge 107.

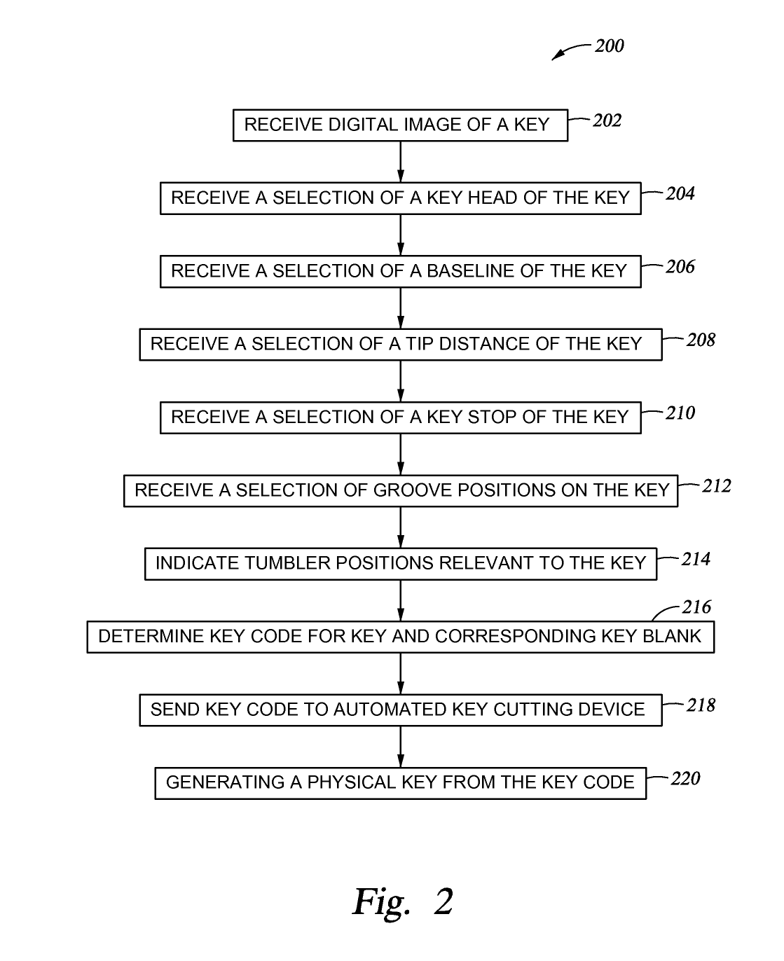

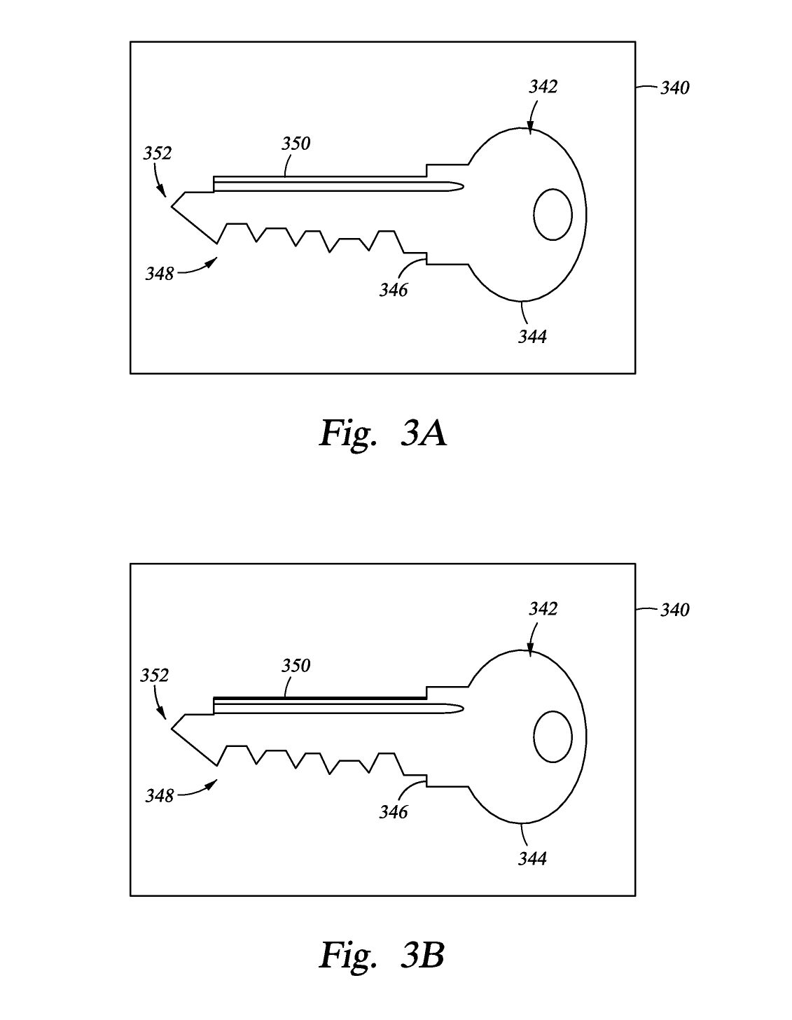

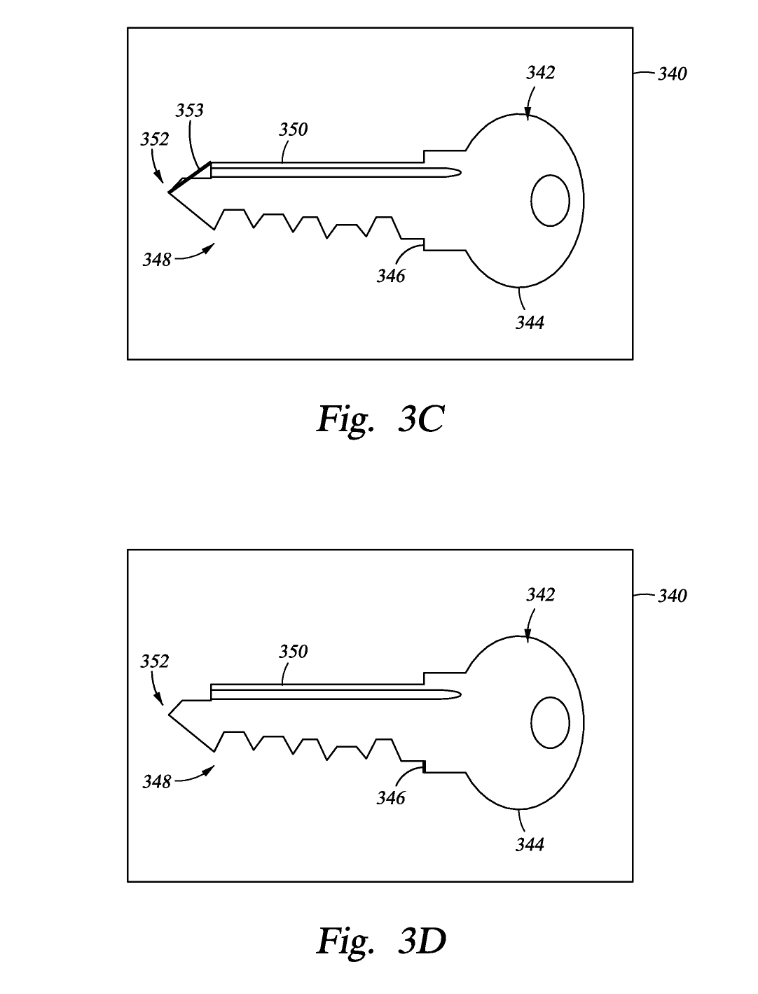

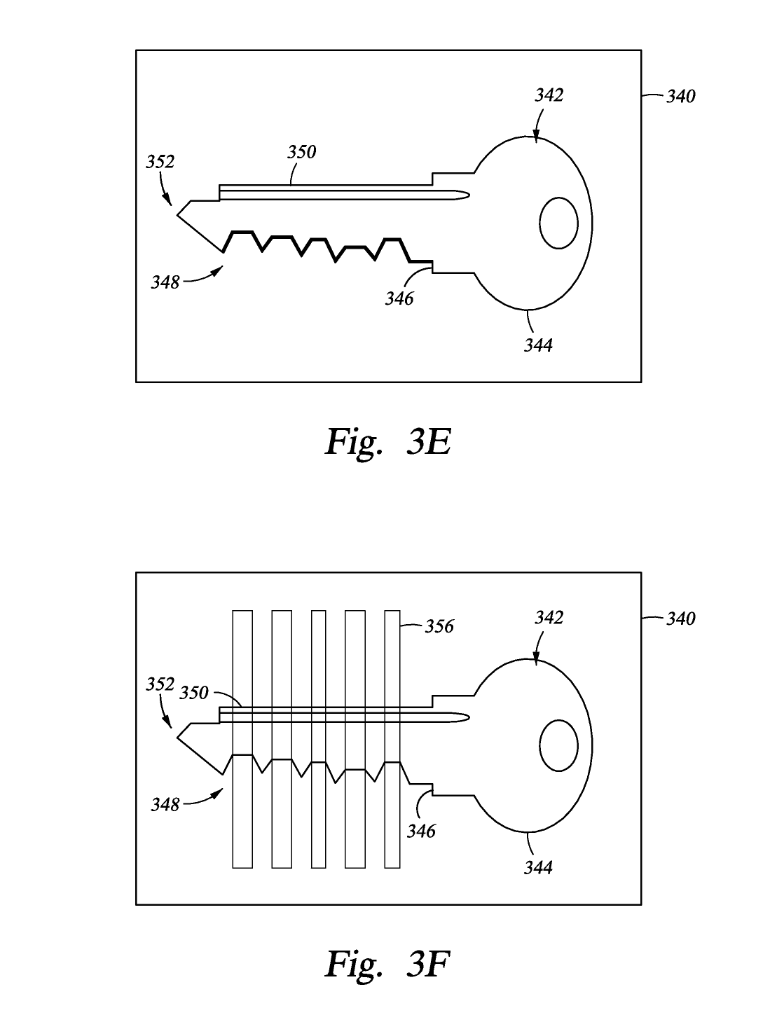

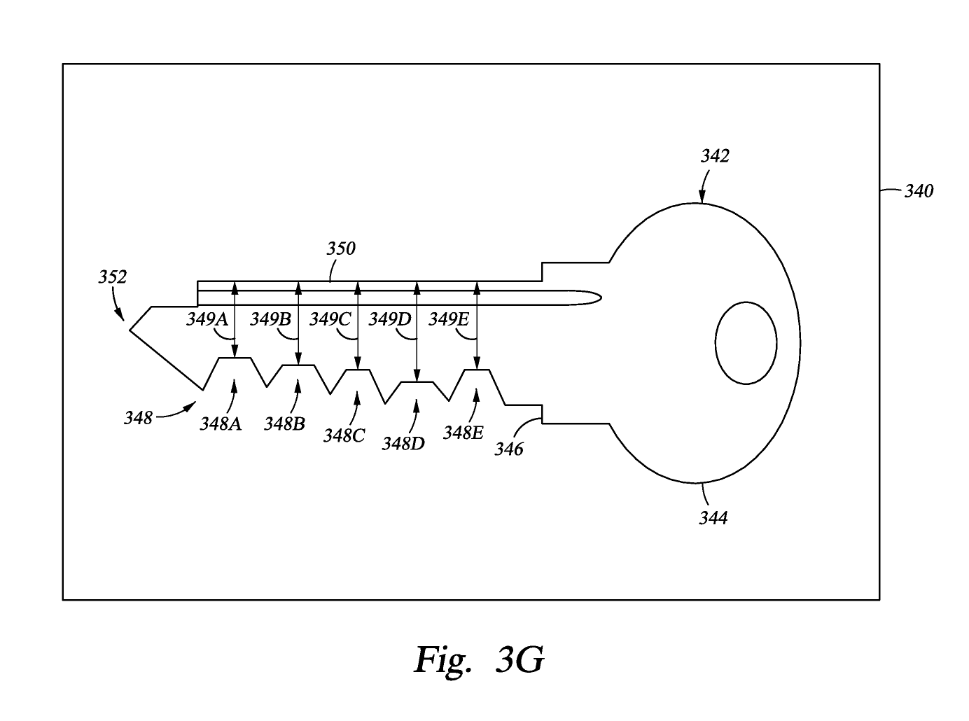

FIG. 2 is a flow diagram 200 illustrating a method of determining a key code, according to one embodiment of the invention, and may be performed, for example, by the software program 106 shown in FIG. 1. FIGS. 3A-3G illustrate operations during determination of a key code, according to one embodiment of the invention. To facilitate explanation of embodiments described herein, FIGS. 2 and 3A-3G will be explained in conjunction with one another.

Flow diagram 200 begins at operation 202, in which a software program receives a digital image 340 of a key 342, as shown in FIG. 3A. The key 342 includes a bow or head 344, a shoulder stop or key stop 346, cuts or grooves 348 opposite a blade or baseline 350, and a tip 352.

In operation 204, the software program receives a selection indicating a head of the key 342. It is contemplated that the selection may be performed by a user of the software program, or by the software program itself by utilizing image recognition software. The key head may be selected from a library of key head images, such as library 109 shown in FIG. 1. Selection of the key head facilities determination of a key code by narrowing the pool of key blanks from which the key 342 is formed. The selection may be performed by a user or by the software program.

In operation 206, the software program receives a selection indicating a baseline 350 of the key 342. The selection of the baseline 350 may be performed by a software user, or by the software program. If the selection is performed by the software program, it is contemplated that the user may have the ability to adjust the selection in the event the software program incorrectly identifies the baseline 350 of the key. As shown in FIG. 3B, the baseline 350 may be highlighted or bolded in the digital image 340 after selection of the baseline 350. In one example of a user selecting the baseline 350, the user may trace the baseline 350 using a mouse or stylus, or may designate the endpoints of the baseline 350 by clicking on the endpoints using a mouse or stylus.

In operation 208, the software program receives a selection indicating a tip 352 of the key 342. Specifically, the selection, which as shown as distance 353 in FIG. 3C, identifies the distance between the tip 352 and the closest endpoint of the baseline 350. The selection of the distance 353 may be performed by a software user, or by the software program. If the selection is performed by the software program, it is contemplated that the user may have the ability to adjust the selection in the event the software program incorrectly identifies the distance 353 of the key 342. As shown in FIG. 3C, the distance 353 may be highlighted or bolded in the digital image 340. When the distance 353 is selected by a user, it is contemplated that a mouse or stylus may be utilized to identify the distance 353.

In operation 210, the software program receives a selection indicating a key stop 346 of the key 342. The selection of the key stop 346 may be performed by a software user, or by the software program. If the selection is performed by the software program, it is contemplated that the user may have the ability to adjust the selection in the event the software program incorrectly identifies the key stop 346. As shown in FIG. 3D, the key stop 346 may be highlighted or bolded in the digital image 340. When the key stop 346 is selected by a user, it is contemplated that a mouse or stylus may be utilized to identify the key stop 346.

In operation 212, the software program receives a selection indicating a position of the grooves 348 of the key 342. The selection of the grooves 348 may be performed by a software user or by the software program which selects or highlights the grooves 348, as shown in FIG. 3E. If the selection is performed by the software program, it is contemplated that the user may have the ability to adjust the selection in the event the software program incorrectly identifies the grooves 348. As shown in FIG. 3E, the grooves 348 may be highlighted or bolded in the digital image 340. When the grooves 348 are selected by a user, it is contemplated that a mouse or stylus may be utilized to identify the grooves 348.

In operation 214, the software program indicates the positions of tumblers in relation to the grooves 348 of the key 342, as shown in FIG. 3F. The software program positions vertical bars 356 over the grooves 348 where the grooves 348 would contact individual tumblers within a lock. The visual appearance of the tumbler contact positions relative to the grooves 348 assists a user in visually confirming that the software application has correctly identified the grooves 348 of the lock 342. The vertical bars 356 may be moved by a user in the event the user disagrees with the software programs placement of the vertical bars.

In operation 216, the software program generates a key code for the key 342 and an item number for a corresponding key blank. The item number for the key blank may be, for example, a catalogue number or model number of a blank key from which the key 342 was formed (and thus, a blank key from which a duplicate of key 342 can be formed). A key code is a numeric code corresponding to a depth of cut for each groove in the grooves 348. When the key having the correct groove depth at each tumbler position is inserted into a lock, the key positions the tumblers at a certain location such that the tumblers allow the cylinder of a key to rotate, and thereby unlocking the lock upon rotation.

The software program generates the key code and the key blank item number by referencing a library, such as library 109, which contains a database of information stored in the library regarding known key blanks produced by key blank manufacturers. Information regarding key blanks includes an item number for each key blank stored in the library (or more than one item number per key, if applicable), key head style, and the physical dimensions of each key blank and the relative ratios thereof. The software program utilizes the selected characteristics of the key 342 (e.g., the baseline, the tip distance, and the key stop) to generate the relative ratios therebetween. The relative ratios and the key head selected in operation 204 are referenced against the data in the library to determine a key blank corresponding to the key 342. Having determined the corresponding key blank, the physical dimensions of the key 342 become known, and key be utilized to determine the dots-per-inch (DPI) of the digital image 340 (e.g., the physical dimensions of the key 342 are known, as are the number of pixels composing the key 342, thus allowing for a determination of DPI).

Having determined the DPI of the image 340, the software program can determine the distance of each groove of the grooves 348 from the baseline of the key by determining the number of pixels therebetween. The distance between the baseline and a particular groove determines the code of the particular groove for purposes of determining the key code. Each distance is correlated with an integer, for example, an integer between 1 and 5. Thus, each groove can have one of five possible groove depths, which is represented by an integer in the key code. As illustrated in FIG. 3G, the key 342 includes five grooves 348A-348E. Each of the grooves 348A-348E includes a corresponding distance 349A-349E from the baseline 350. Each of the distances 349A-349E corresponds to a numeric value for a particular key blank. A string of the numeric values represents a key code. Thus, the key code represents the particular depth to which each groove (generally starting from the head of a key) should be cut. In one example, the key 342 shown in FIG. 3G may have a key code of “2-1-2-3-4”. Generally, a higher numerical integer indicates a deeper groove depth. They key code may be displayed on a display device, such as display device 110 shown in FIG. 1, or may be stored in a memory, such as system memory 104 or system disk 114 shown in FIG. 1.

In one embodiment, the software program may generate more than one key code for the key 342. In such an embodiment, the software program may also generate a corresponding probability of being correct for each digit in each of the key codes, or alternatively, a corresponding probability of being correct for each key code in entirety. For example, the software program may generate a first key code of “2-1-2-3-4” for key 342 with corresponding probabilities of “99-98-99-60-98” percents. The software program may also generate a second key code of “2-1-2-4-4” with corresponding probabilities of “99-98-99-40-98” percents. Thus, in such an example, the software program determines that the fourth groove (e.g., groove 348B) has a 60 percent chance of being a “3” and a 40 percent chance of being a “4”. The generation of multiple key codes and corresponding probabilities may occur when ascertaining the key code of old, worn keys, or when the image of the key 342 is unclear due to a poor quality, bad lighting, and the like. Moreover, the software program may optionally provide more than one item number for a key blank when more than one key blank may be applicable.

Having determined a key code in operation 216, the software program may then send the key code, and optionally, a key blank item number, to an automated key cutting device in operation 218. Utilizing the key code, the automatic key cutting device may generate a physical key from the key code in operation 220. Thus, as illustrated by flow diagram 200, a physical key can be produced from a digital image of the key.

FIGS. 2 and 3A-3G illustrate some embodiments; however, other embodiments are also contemplated. For example, it is to be understood that the key 342 is merely one example of a key, and many other variations and types of keys may be utilized in the flow diagram 200. In another embodiment, when selections of the baseline, 350, the tip distance 353, the key stop 346, or the grooves 348 are performed by a user, it is contemplated that the user may have the ability to zoom in the digital image 340 to enhance the accuracy of the selection. In another embodiment, it is contemplated that operations 214, 218, and 220 may be optional. In another embodiment, it is contemplated that a physical copy of the key 243 may be produced manually from a key code, rather than by an automated key cutting machine. In yet another embodiment, it is contemplated that the key code may be uploaded or stored on a server for access at a later time or for access by another party, such as a locksmith.

In yet another embodiment, it is contemplated that any of operations 202-218 may be performed on or by a server or other remote computing device. It is also contemplated that operations 202-218 may be performed by any combination of a local computing device or a remote computing device. For example, some of operations 202-218 may be performed on a local computing device, while the remainder of operations 202-218 may be performed by the remote computing device. Thus, in such an embodiment, it is contemplated that some data may be “pushed” to a server or remote computing device, and processed by the server or remote computing device.

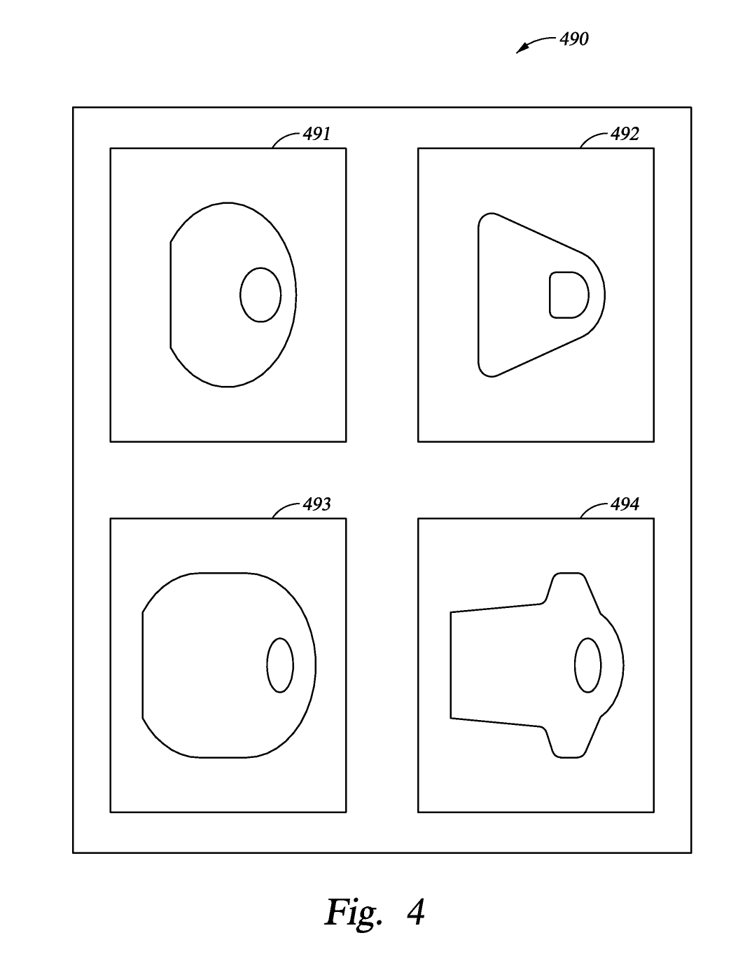

FIG. 4 illustrates a key head library 490, according to one embodiment of the invention. The key head library includes four selectable images of key heads 491-494. It is to be appreciated that the key head library 490 is only one example of a key head library, and other libraries may contain many additional examples and selections. The key head library 490 is one example of a library that may be accessed during operation 216 shown in FIG. 2.

Benefits of the invention include the ability to produce a physical key from a digital image of a key. Thus, the party producing the key does not need to be in possession of a key to make a physical copy of that key. In addition, key owners can capture digital images of a key upon receiving a key. The digital image can be stored and later used to produce a copy of a key in the event the original key is ever lost. Thus, embodiments described herein facilitate the duplication of a key when it is needed most—after the original has been lost. Such embodiments eliminate the need to duplicate a key upon receiving the key, because a key possessor can wait until a key is actually lost before seeking to reproduce a key. More often than not, the original key is never lost, and the duplicate of the key is never needed. Because unnecessary duplicates need not be manufactured, the wasting of resources is avoided.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

What is claimed is:

1. A method of determining a key code, comprising:
determining a key head of a key;
determining a baseline of the key;
determining a tip distance of the key;
determining a key stop of the key;
determining groove positions on the key; and
determining a key code for the key.

2. The method of claim 1, wherein determining the groove positions includes tracing the groove positions using a mouse or stylus.

3. The method of claim 1, further comprising determining a probability of accuracy of the key code.

4. The method of claim 3, further comprising determining a second key code for the key, and a probability of accuracy of the second key code.

5. The method of claim 1, further comprising generating a physical key from the key code.

6. A method of determining a key code, comprising:
receiving a selection indicating a key head of a key;
receiving a selection indicating a baseline of the key;
receiving a selection indicating a tip distance of the key;
receiving a selection indicating a key stop of the key;
receiving a selection indicating groove positions on the key; and
determining a key code for the key.

7. The method of claim 6, wherein the selection indicating a key head of a key, the selection indicating a baseline of the key, the selection indicating a tip of the key, and the selection indicating a key stop of the key are performed by a user.

8. The method of claim 6, wherein the selection indicating a key head of a key, the selection indicating a baseline of the key, the selection indicating a tip of the key, and the selection indicating a key stop of the key are performed by a software program.

9. The method of claim 6, wherein the selection indicating the groove positions are traced by a user.

10. The method of claim 6, wherein the selection indicating the groove positions are traced by a software program.

11. The method of claim 6, further comprising determining a probability of accuracy of the key code.

12. The method of claim 11, further comprising determining a second key code for the key, and a probability of accuracy of the second key code.

13. The method of claim 12, further comprising determining a part number of a key blank corresponding to the key.

14. The method of claim 6, further comprising indicating tumbler positions relevant to the key.

15. The method of claim 14, wherein the tumbler positions are adapted to be changed via user input.

16. The method of claim 6, further comprising sending the key code to an automated key cutting machine.

17. The method of claim 16, further comprising generating a physical key from the key code.

18. The method of claim 6, further comprising generating a physical key from the key code.

19. The method of claim 6, further comprising receiving a digital image of the key.

20. A non-transitory computer-readable medium including instructions that, when executed by a processing unit of a computer system, cause the computer system to perform the operations of:
receiving a selection indicating a key head of a key;
receiving a selection indicating a baseline of the key;
receiving a selection indicating a tip distance of the key;
receiving a selection indicating a key stop of the key;
receiving a selection indicating groove positions on the key; and
determining a key code for the key.
